(19) United States
(12) Patent Application Publication
(10) Pub. No.: US 2023/0348314 A1
(43) Pub. Date: Nov. 2, 2023

(54) LIGHT-SENSITIVE GLASS AND PROCESS FOR INSCRIBING STRUCTURES FORMED FROM VARIATIONS IN BULK REFRACTIVE INDEX IN SUCH A GLASS

(71) Applicants: UNIVERSITE DE BORDEAUX, Bordeaux (FR); INSTITUT POLYTECHNIQUE DE BORDEAUX, Talence (FR); CENTRE NATIONAL DE LA RECHERCHE SCIENTIFIQUE - CNRS, Paris (FR); COMMISSARIAT A L'ENERGIE ATOMIQUE ET AUX ENERGIES ALTERNATIVES, Paris (FR)

(72) Inventors: Thierry CARDINAL, Salles (FR); Sylvain DANTO, Merignac (FR); Evelyne FARGIN, Gradignan (FR); Théo GUERINEAU, Talence (FR); Yannick PETIT, Begles (FR); Lionel CANIONI, Gradignan (FR); Romain LABERDESQUE, Bures-sur-Yvette (FR)

(21) Appl. No.: 18/245,781

(22) PCT Filed: Sep. 20, 2021
(86) PCT No.: PCT/FR2021/051598

§ 371 Date: Mar. 17, 2023

(30) Foreign Application Priority Data
Sep. 21, 2020 (FR) FR20 09534

(51) Int. Cl. C03B 33/09

(52) U.S. Cl. CPC C03B 33/091

(57) ABSTRACT

The invention relates to a process for inscribing a three-dimensional structure formed from variations in refractive index in the bulk of a transparent oxide glass comprising silver ions by femtosecond-laser-beam irradiation, the method comprising: generating a laser beam made up of a series of ultra-brief light pulses of pulse duration shorter than the characteristic time of thermalization of the glass so as to achieve an excitation at the point of irradiation via multi-photon interaction; focusing said beam at a desired depth in the glass; irradiating point by point the glass with said beam so as to form the structure in the glass along a predetermined path, the number of pulses, the repetition rate of the pulses and the irradiance at each irradiation point being controlled to induce an accumulation of silver aggregates localised in an annular peripheral region around an irradiation point, said accumulation of aggregates generating a variation in refractive index in the annular peripheral region around the irradiation point, and to erase a variation in refractive index in a segment of an annular peripheral region generated around another irradiation point when said segment of the peripheral region coincides with a region of the laser beam.

### TECHNICAL FIELD

The present invention relates to novel compositions of oxide glasses that are photosensitive and transparent in the visible and the infrared. More particularly, the present invention relates to glasses that are photosensitive and transparent for wavelengths between 400 nm and 800 nm in the visible spectral range and between 800 nm and 8000 nm in the infrared range.

The present invention relates also to a method for writing structures of modulation of refractive index in the volume of such a transparent and photosensitive glass by femtosecond laser beam irradiation. In particular, the method is suitable for producing three-dimensional structures of modulation of refractive index to form a Bragg grating.

### PRIOR ART

A Bragg grating describes, generally, a periodic modulation of optical refractive index produced in a transparent material in order to filter the incident light. The Bragg grating reflects the incident light at a particular wavelength, called Bragg wavelength and transmits the other wavelengths of the spectrum. The efficiency of the spectral response of a Bragg grating depends partly on the following parameters: the pitch of the refractive index modulation or the pitch of the grating Λ (or the spatial frequency f = 1/Λ), the length of the grating and Δn the amplitude of the refractive index modulation, as well as the index modulation profile constituting each modulation period. It is thus possible to optimize the diffraction efficiency of the grating by adjusting the different parameters, notably the modulation period and the modulation amplitude.

A Bragg grating can be produced in guided configuration, in the core of an optical fiber, or in free space, in the bulk of a substrate. In the second configuration, it is a bulk Bragg grating which is an essential optical component used notably for the wavelength stabilization of lasers on the one hand, and also for the spectral filtering in high-resolution spectroscopy on the other hand.

One conventional means of obtaining a Bragg grating in a transparent material consists in submitting photosensitive transparent material to a lighting with spatial profile of sinusoidal type obtained by the interference of two beams at the wavelength of sensitivity of the material, in order to modulate the refractive index provoked by a variation of the distribution of charges within the glass. The grating is then stabilized and made permanent by curing techniques.

### Technical Problem

Germanium-doped silicate material is known for producing the optical fibers in telecommunications. However, the amplitude of the variation of optical refractive index induced by UV insulation is limited more often than not to some 10⁻⁵.

It is also known practice to use a novel, so-called photothermoreactive (PTR) material to produce a bulk Bragg grating. This is a glass composed of a mixture of oxides, silica, zinc and aluminum and doped with photosensitive silver ions, fluorine and cerium. The index variations are obtained according to a photothermic process based on the precipitation of dielectric microcrystals inside the glass, once the latter has been exposed to a UV radiation and thermally treated beyond the glass transition temperature. This material can be set in the form of a thin and easily polishable blade because of its composition and its glassy nature. The glass obtained is transparent in the visible and offers a transmission range between 0.3 and 3 microns. However, this material is not very well suited for optical applications demanding a spectral light transmission window beyond 3 microns. Moreover, the notion of transparency has to be modulated according to the applications targeted: as well as being transparent in the infrared, the existing losses do not allow realistic applications in terms of laser sources beyond 2 µm.

To obtain an efficient bulk Bragg grating, it is essential to be able to work in a wide spectral band in order to be able to cover the high-energy optical applications. It must have a perfect control of the periodicity of the grating with great spatial resolution. Moreover, the index modulation must be as high as possible, generally greater than some 10⁻³.

The emergence of femtosecond laser sources has made it possible to develop direct 3D laser writing technologies in transparent materials such as glass. However, no direct laser writing technique has been demonstrated satisfactorily to allow the direction inscription of optical refractive index modulation structures of submicron dimension in depth in a transparent glass beyond 3 microns.

There is therefore a need for novel glasses that are transparent both in the visible and infrared ranges up to 8 microns, to be able to be incorporated in high-energy optical applications. Another object of the present invention is to propose a photosensitive transparent glass that has a composition suitable for allowing a bulk photo-structuring by a short and ultrashort pulsed laser beam, in order to be able to produce three-dimensional structures of high optical refractive index modulation, generally greater than some 10⁻³, with a submicronic spatial resolution, and with great repeatability.

### SUMMARY OF THE INVENTION

One subject of the present invention therefore relates to transparent glasses based on oxides of silica, of phosphate or of germanium containing photosensitive silver ions suitable for bulk inscription of a structure by a femtosecond laser beam.

### Glasses

The transparent glass according to the present invention comprises at least 99% to 100%, by weight, with respect to the total weight of the material, of a composition of the following formula (I):

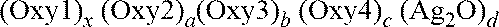

in which Oxy1 is a glass-forming oxide chosen from among an oxide of silicon SiO₂, an oxide of germanium, or an oxide of phosphate, and
Oxy2 represents an oxide chosen from among Ga₂O₃, Al₂O₃, ZnO,
Oxy3 represents an oxide chosen from among MgO, CaO or BaO, and
Oxy4 represents an oxide chosen from among Na₂O, K₂O, Rb₂O or Li₂O, and
x comprised between 30 and 80, and
a comprised between 0 and 65, and
b comprised between 0 and 65, and
c comprised between 0 and 65,
d comrised between 0.1 and 10, and
x, a, b, c and d are such that x+a+b+c+d = 100, and
in which the numbers x, a, b, c and d represent molar proportions.

### Phosphates

The glass according to the present invention comprises at least 99%, by weight, with respect to the total weight of the material, of a composition of the following formula (II):

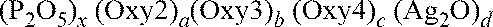

in which
the forming oxide is an oxide of phosphate,
Oxy2 represents oxides such as Al₂O₃, Ga₂O₃, ZnO, preferably Ga₂O₃,
Oxy3 represents an oxide chosen from among CaO, MgO or BaO, preferably MgO,
Oxy4 represents an oxide chosen from among Na₂O, K₂O, Rb₂O or Li₂O, preferably Na₂O,
x lies between 25 and 35, preferably 31
a lies between 5 and 35, preferably 20.6
b lies between 0 and 50, preferably 0
c lies between 0 and 50, preferably 46.4
d lies between 0.1 and 10, preferably 2.0
x, a, b, c and d are such that x+a+b+c+d = 100, and
in which the numbers x, a, b, c and d represent molar proportions.

### Germanates

In a particular embodiment, the oxide chosen to form the glassy matrix is an oxide of germanium. The compositions according to this embodiment will be called germanates.

The glass according to the present invention comprises at least 99%, by weight, with respect to the total weight of the material, of a composition of the following formula (III):

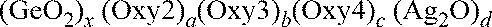

in which
the forming oxide Oxy1 is an oxide of germanium,
Oxy2 represents an oxide chosen from among Ga₂O₃, Al₂O₃, ZnO,
Oxy3 represents an oxide chosen from among MgO, CaO or BaO, preferably BaO,
Oxy4 represents an oxide chosen from among Na₂O, K₂O, Rb₂O
or Li₂O, preferably K₂O,
x lies between 35 and 45, preferably 43.9
a lies between 0 and 40, preferably 8.8
b lies between 0 and 50, preferably 42.1
c lies between 0 and 50, preferably 3
d lies between 0.1 and 10, preferably 2.2
x, a, b, c and d are such that x+a+b+c+d = 100, and
in which the numbers x, a, b, c and d represent molar proportions.

According to an embodiment of the invention, the glass further comprises halogenated compounds (fluoride, chloride, bromide) whose function is to modulate the photosensitivity or to facilitate the shaping and the purifying of the glass.

According to an embodiment of the invention, the glass further comprises dopants supplementing the composition of the formula (I), (II) or (III) to reach the 100% weight. According to the invention, the dopants are chosen from among the following metallic ions: Ag⁺, Au³⁺, Cu⁺.

According to an embodiment of the invention, the glass as defined above exhibits a transmission greater than 90% in a range comprised between 400 nm and 8000 nm.

Another subject of the present invention relates to a method for writing a three-dimensional structure of variation of refractive index by a femtosecond laser beam in a photosensitive transparent oxide glass comprising silver ions as defined above, the method comprising:
generating a laser beam composed of a series of ultrashort light pulses with a pulse duration shorter than the characteristic time of thermalization of the glass so as to produce an excitation at the irradiation point by multiphotonic interaction between for example 100 femtoseconds and 0.5 picoseconds;
focusing said beam at a desired depth in the glass;
irradiating the glass point by point by said beam so as to form the structure in the glass along a predetermined trajectory, the number of pulses, the repetition rate of the pulses and the irradiance at each irradiation point being controlled to induce an accumulation of silver aggregates located in an annular peripheral zone around an irradiation point, said accumulation of silver aggregates generating a variation of optical refractive index in the annular peripheral zone around the irradiation point and to erase a variation of optical refractive index in a portion of an annular peripheral zone generated around another irradiation point when said portion of the peripheral zone coincides with a zone of the laser beam.

According to an embodiment of the invention, the variation of refractive index Δn is a positive variation of at least greater than 10⁻³.

The features set out in the following paragraphs can, optionally, be implemented. They can be implemented independently of one another or in combination with one another:
the sample is moved in translation in a direction so as to form a line of passage of the laser beam formed according to a set of irradiation points, the distance between two irradiation points being substantially equal to half the diameter of the laser beam such that the passage of the laser beam forms two planes of variation of refractive index on either side of the line of passage of the beam;
the sample is moved in another direction between two lines of passage of the laser beam so as to form a succession of lines of passage of the beam, the distance between two lines of passage of the beam being less than the diameter of the laser beam such that the succession of passages of laser beam form a grating of planes of variation of refractive index that are parallel to the line of passage of the laser beam;
the repetition rate is greater than 10 kHz;
the pulse duration of the laser beam between 100 femtoseconds and 0.5 picoseconds and, the duration being shorter than the characteristic time of thermalization of the glass so as to produce an excitation at the irradiation point by multiphotonic interaction:
the irradiance between 7 TW.cm⁻² and 8.4 TW.cm-²;
the laser beam is emitted with a wavelength between 515 nm and 1200 nm, preferably at 1030 nm;
the sample is moved with respect to the laser beam at a speed V_{D} between 50 µm.s⁻¹ and 1000 µm.s⁻¹.

According to an embodiment of the invention, the structure produced is formed by at least one plane of variation of refractive index, the thickness of said plane being less than 200 nm, substantially equal to 80 nm.

According to another embodiment of the invention, the structure produced is a periodic structure comprising a plurality of planes of variation of refractive index to form a bulk Bragg grating, with a grating pitch Λ between 200 nm and 1.5 µm.

According to another aspect of the invention, also proposed is a bulk Bragg grating comprising a grating of planes of variation of refractive index, the variation of refractive index being greater than 10⁻³, the thickness of each plane being less than 200 nm, preferably substantially equal to 80 nm, the pitch of the grating between 200 nm and 1.5 µm.

### BRIEF DESCRIPTION OF THE DRAWINGS

Other features, details and advantages of the invention will become apparent on reading the following detailed description, and on analyzing the attached drawings, in which:

[FIG. 1] shows a device implementing the method for writing structures of modulation of refractive index in the volume of a photosensitive glass according to the invention;

[FIG. 2] schematically illustrates a spatial distribution of silver aggregates around an irradiation point upon a spot irradiation according to the method of the invention;

[FIG. 3A] schematically illustrates the inscription in a sample upon a translational movement of the sample in the direction X, to form, in a laser passage, a distribution of variation of optical refractive index corresponding to two zones of positive variation of index on the edges of the focusing point, these zones being separated by a distance D which reflects the distance between the modifications on either side of the focusing point of the laser beam, the distance D being defined by the size of the focused laser beam, the deposited energy dose which depends on the cumulative number of pulses at the focusing point and on the irradiance used;

[FIG. 3B] shows the inscription of FIG. 3A followed by a second laser passage performed in the reverse direction or in the same direction, with a center-to-center lateral movement Δy to inscribe, which can then be generalized to N laser passages and Δy defining the periodicity of the Bragg grating; the center-to-center lateral movements being smaller than the distance separating two zones of variation of index in the preceding passage, such that Δy < D, and chosen such that one of the two zones of variation of index inscribed in the first laser passage is covered by the second laser passage, leading to the erasure of the variation of optical refractive index of this zone, while the other zone of variation of index inscribed in the first laser passage remains. Thus, in the second passage, two new zones of variation of index are re-inscribed; this capacity for reinscription in the photosensitive glass is a central point of the method of the present invention, which makes it possible to conserve, laser passage after laser passage, only one of the two zones of variation of index, with the spatial period imposed by the center-to-center lateral movement Δy of the laser;

[FIG. 4] schematically illustrates in more detail according to a top view the principle of formation of two planes of variation of refractive index on either side of the line of passage of the laser beam of FIG. 3A from a quasi-continuous succession of irradiation points, the distance between two irradiation points Δx being very much less (up to 100 nm) than the diameter of the laser beam D which is a micronic dimension, linked to the pairs of parameters applied which are the high repetition rate of the laser and the moderate speed of movement of the sample;

[FIG. 5] schematically illustrates, according to a profile view, the formation of two planes of variation of refractive index on either side of each line of passage of the laser beam, when the distance between two lines of passage of the laser beam Δy is greater than the diameter of the beam; this does not correspond to the embodiment of the method of the invention because the overall periodicity of the pattern is not suited;

[FIG. 6] represents the formation of a grating of planes of variation of refractive index after a succession of lines of passage of the laser beam according to an embodiment of the method of the invention, the distance between two lines of passage of the laser beam Δy being on the one hand less than the diameter of the beam and on the other hand adjustable, making it possible to control the spatial periodicity required for the production of the bulk Bragg grating;

[FIG. 7] represents a trend of refractive index at 480, 589, 644 and 656 nm for a series of silver ion-doped germanium-gallium-barium-potassium glasses (GGBK) as a function of the BaO content;

[FIG. 8] represents a spectrum of the absorption coefficient in the UV-visible-mid IR region for the potassium and barium germane-gallate glasses (BaO: 0%), GGB5K (BaO: 5%), GGB10K (BaO: 10%) and GGB15K (BaO: 15%);

[FIG. 9] represents a trend of the absorption coefficient in the UV-visible-mid IR region for the GGB15K (BaO: 15%) and BGGK (BaO: 37.5%) glasses with, in the inset, a zoom in the UV-blue range;

[FIG. 10] represents excitation and emission spectra of the GGB15K and BGGK glasses;

[FIG. 11] represents (a) a confocal microscopy image of fluorescence under an excitation at 405 nm showing a matrix of structures inscribed in the BGGK glass at different irradiances (7.3 TW.cm⁻² -8.9 TW.cm⁻ ²) and at different speeds (50 µm.s⁻¹ -1100 µm.s⁻¹), (b) a zoom of the image (a) showing one of the structures inscribed with an irradiance of 8.4 TW.cm⁻² and at a speed of 50 µm.s⁻¹ and (c) a zoom of the image (a) showing one of the structures inscribed with an irradiance of 7.3 TW.cm⁻² and at a speed of 350 µm.s⁻¹;

FIG. 12 [FIG. 12] respectively represents confocal microscopy images of fluorescence and of phase contrast for the structures inscribed in the BGGK glass with an irradiance of 8.4 TW.cm⁻² and a speed of 50 µm.s⁻¹ (images a and c) and with an irradiance of 7.3 TW.cm⁻² and a speed of 350 µm.s⁻¹ (images b and d);

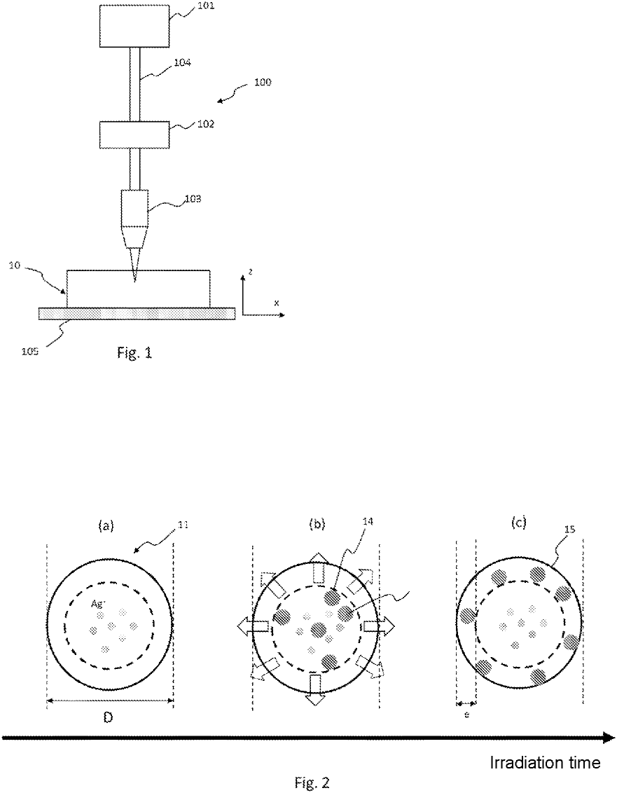

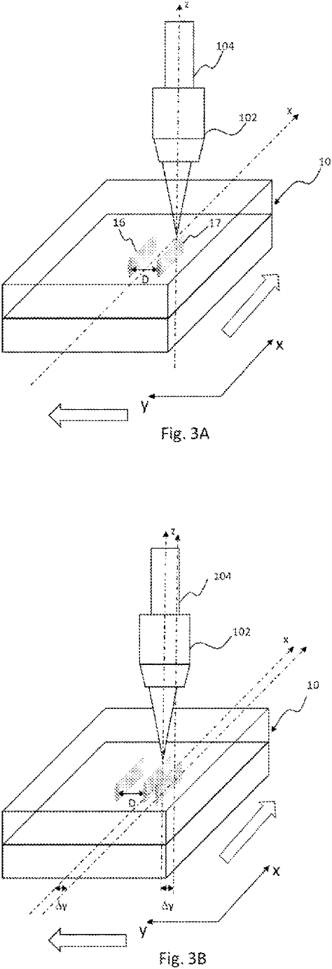

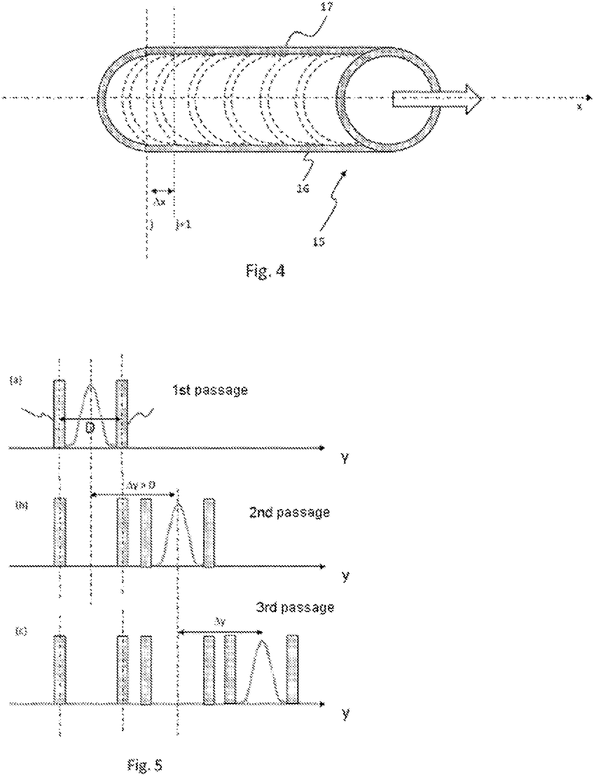

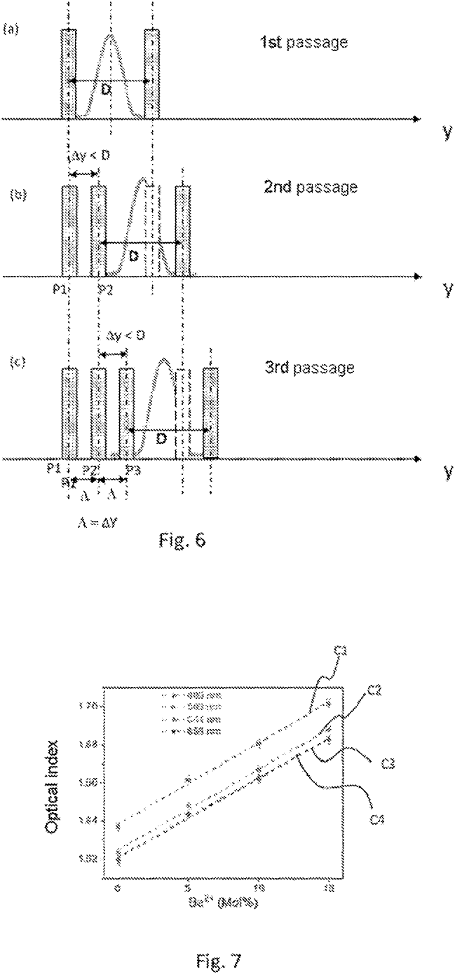

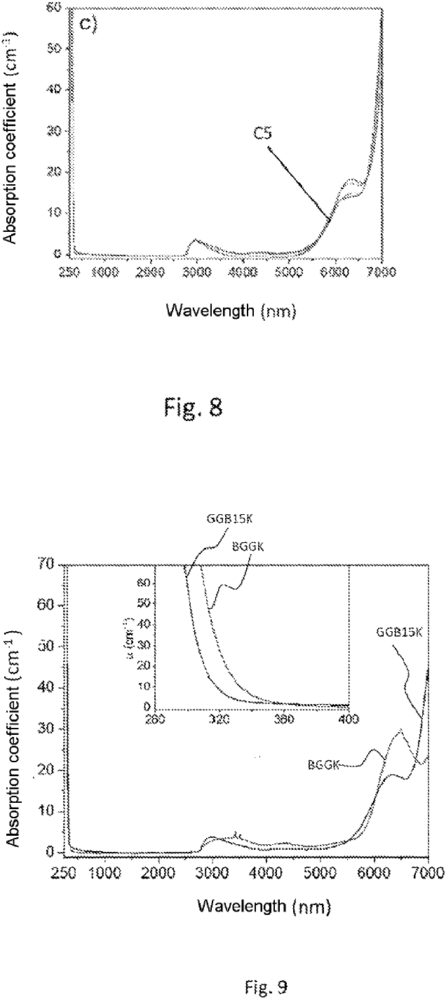

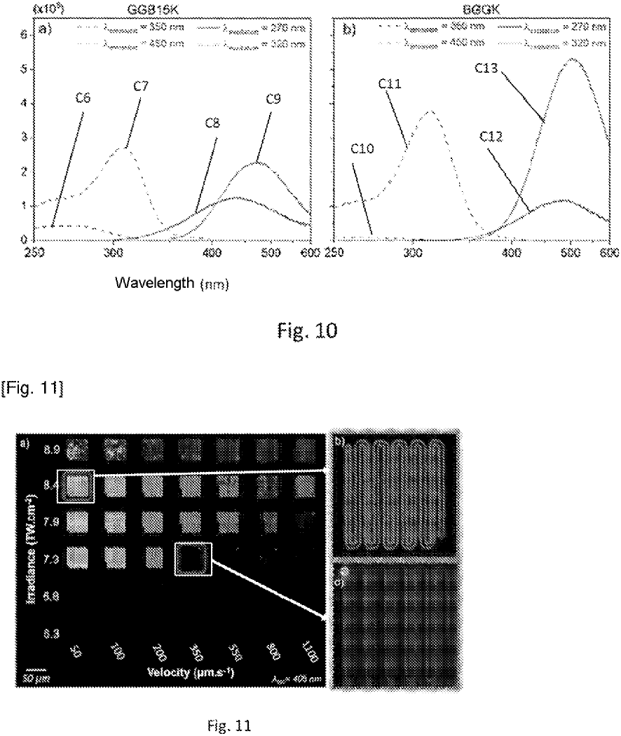

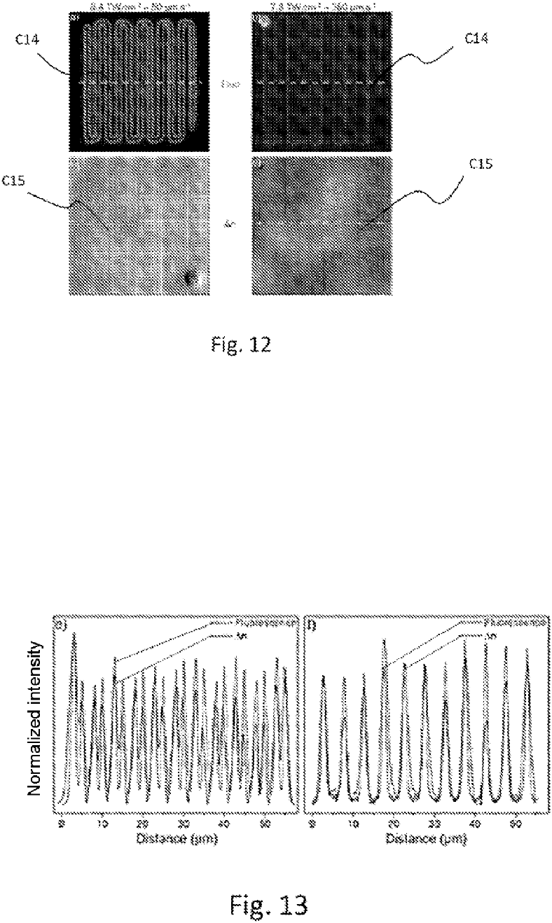

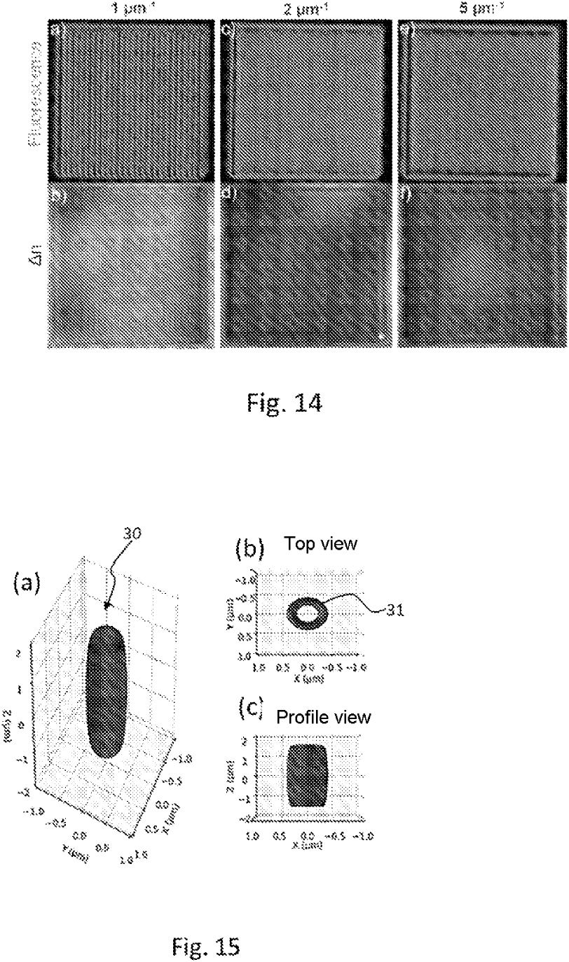

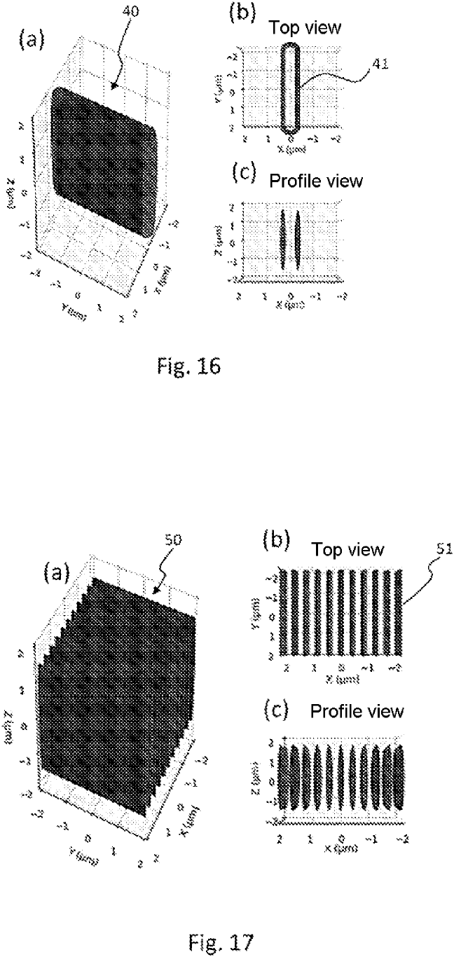

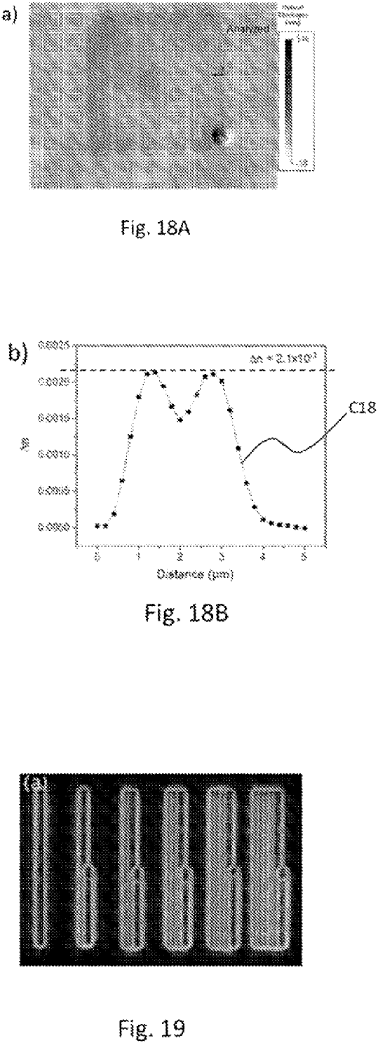

[FIG. 13] represents an overlay of the profiles of fluorescence intensity and of variation of refractive index in a direction indicated by the broken lines in FIG. 12;

[FIG. 14] represents confocal microscopy images of fluorescence under 405 nm excitation (images a, c and e) and images of phase contrast (images b, d and f) of three structures inscribed in the BGGK glass respectively with a laser passage density per micrometer of 1 µm⁻¹, 2 µm⁻¹ and 5 µm⁻¹, with structures of periods which become here so small that they become close to or even less than the diffraction limit and therefore than the limit of resolution of the two microscopes used;

[FIG. 15] represents the digital simulation typically representing a structure of variation of refractive index in the form of tubes inscribed in a silver ion-doped gallium-phosphate-sodium glass (GP) upon a spot irradiation according to a perspective view (a), according to a top view (b) and according to a profile view (c);

[FIG. 16] represents the simulation typically representing a structure formed by two planes of variation of refractive index inscribed in the GP glass when the glass is moved in translation with respect to the beam in a direction to produce a line of passage of the laser beam, the image being shown according to a perspective view (a), according to a top view (b) and according to a profile view (c);

[FIG. 17] represents the simulation typically representing a grating of planes of variation of refractive index inscribed in the glass GP when the glass is moved in translation with respect to the beam in a direction to produce a succession of lines of passage of the laser beam with a regular interval, the image being shown according to a perspective view (a), according to a top view (b) and according to a profile view (c);

[FIG. 18A] represents an image of phase contrast of a structure of variation of refractive index inscribed in a GP glass with a line of passage of the femtosecond pulsed laser beam;

[FIG. 18B] represents a profile of variation of refractive index of a portion of the structure of FIG. 18A along a line indicated in the image;

[FIG. 19] represents a high-resolution image of fluorescence of a periodic structure of planes of variation of refractive index inscribed by the property of reinscription in the GP glass with a distance between two lines of passage of the laser beam equal to 1.1 µm, this distance being less than the diameter of the laser beam.

For greater clarity, the elements identical or similar are identified by identical reference symbols throughout the figures.

### DEFINITIONS

In the context of the present disclosure, “glass” is understood to mean an amorphous inorganic solid, exhibiting the glass transition phenomenon. Glass is obtained by cooling from a liquid phase.

In the context of the present disclosure, “transparent” is understood to mean a material that can be seen through. The transparency of a material is specified by measurements of transmission of a light beam. A material is considered transparent for a given wavelength when its transmittance is greater than or equal to 90% excluding Fresnel reflection.

In the present description, the terms “material” or “materials” designate the transparent glasses of the present invention.

In the context of the present disclosure, the numbers x, a, b, c and d relating to the reference composition of the formula 1 represent molar proportions. Furthermore, in the present invention, when a number is indicated comprised between two values, the limits indicated are included in the range of values. Thus, “x lies between 25 and 35” is understood to mean that x is comprised between 25 and 35, 25 and 35 being included.

In the context of the present disclosure, “femtosecond laser” is understood to mean a laser which delivers pulses of a duration comprised between a few femtoseconds and a few hundreds of femtoseconds.

In the context of the present disclosure, “repetition rate” is understood to mean the number of laser pulses per second. When the delay between two successive pulses is shorter than the thermal relaxation time of the glass, there is thermal accumulation and the temperature of the material at the point of impact of the beam increases progressively. This thermal charge induces a zone of physical-chemical modification around the irradiation point, in order to inscribe a structure of variation of refractive index. It should be noted that the thermal accumulation is weak in the present method, with a temperature rise much lower than the glass transition temperature. That means that there is no melting/annealing of the glass under laser irradiation, nor any significant modifications of the glassy matrix: there is only a photo-activation of the mobility of the silver ions, with the pulse-after-pulse creation of a local variation of index supported by the spatial distribution of new silver species created in the process.

In the context of the present disclosure, “focusing zone” is understood to mean a zone of interaction resulting from the impact of the spot of the laser beam in a focal plane situated at a depth in the glass.

In the context of the present disclosure, “inscription of a structure in bulk in a glass” is understood to mean an inscription of a structure of local variation or modulation of optical refractive index at a depth of the glass induced by impacts of the laser beam, linked with the result of the photochemistry induced on the silver elements but without modifying the structure of the glassy matrix.

In the context of the present disclosure, “submicronic resolution” is understood to mean a spatial resolution between 5 nm and 1 µm, preferably between 5 and 500 nm.

In the context of the present application, “sub-diffraction” is understood to mean a resolution lower than the optical resolution limited by the diffraction of the light at the wavelength considered.

### DESCRIPTION OF THE EMBODIMENTS

The drawings and the description hereinbelow contain, for the most part, elements of a certain nature. They will therefore not only serve to give a better understanding of the present invention, but will also contribute to the definition thereof, where appropriate.

### Method for Manufacturing Glasses of the Invention

The glasses are produced according to a conventional glassmaking method associated with a choice of the compositions of formula (I) of the present invention.

The manufacturing method comprises the following successive steps:
the oxide powders of the composition have been weighed in the desired proportions and then mixed;
the mixture is then melted to a temperature lying between 800° C. and 1700° C. This melting time is suitable for guaranteeing a uniform dispersion of the Ag+ ion on an atomic scale to obtain glasses that are optically adapted to receive femtosecond laser irradiation points. The heating can be performed in a conventional furnace;
the mixture, in the molten liquid state in the crucible, is then subjected to a water tempering to set the mixture while ensuring the uniformity of the mixture;
the mixture is then subjected to a thermal annealing, at a temperature lower than the glass transition temperature of the glass.

In a last step, the glass is cut to a given thickness, to a thickness of 1 mm for example. This thickness can be adapted to greater thicknesses according to the requirements, notably for the production of bulk Bragg gratings, the height of which can be several mm, then optically polished on two parallel faces for the phase of structuring by a femtosecond laser beam.

The starting oxides and their possible precursors are in conventional commercial powder form. The oxide precursors can be in a carbonate form. For example, a precursor of Na₂O can be Na₂CO₃ and that of K₂O can be in the form of K₂CO₃. In this case, the mixture then undergoes a decarbonation treatment in order to eliminate the CO₂ in order to obtain the oxide of the composition.

### Oxide Glasses

The glass according to the present invention, which is photosensitive and transparent, comprises a composition of the following formula (I):

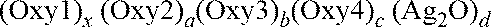

in which Oxy1 represents a forming oxide, chosen from among P₂O₅, GeO₂ or SiO₂,
Oxy2 represents an oxide chosen from among Ga₂O₃, Al₂O₃, ZnO,
Oxy3 represents an oxide chosen from among MgO, CaO or BaO, and
Oxy4 represents an oxide chosen from among Na₂O, K₂O, Rb₂O or Li₂O, and
x lies between 30 and 80, and
a lies between 0 and 65, and
b lies between 0 and 65, and
c lies between 0 and 65, and, and
d lies between 0.1 and 10, and
x, a, b, c and d are such that x+a+b+c+d = 100, and
in which the numbers x, a, b, c and d represent molar proportions.

In the formula (I) above, the oxides Oxy1 represent the glass-forming oxides.

According to the invention, the oxides of silicon, of germanium or of phosphate are associated with oxides of gallium. The two oxides represent the two essential components of the materials of the present invention.

In the materials according to the present invention, contrary to the materials of the prior art, the materials according to the present invention comprise a significant Na₂O and BaO content. The addition of the oxides Oxy3 makes it possible to contribute to the mobility of the silver ions and to confer particular properties of inscription and of reinscription of structures of variation of refractive index by a laser beam of femtosecond pulse duration. The oxides Oxy2 make it possible to reduce the melting temperature and to minimize the problems of crystallization.

In an embodiment, the material of the present invention further comprises silver ions to confer the property of photosensitivity of the material. This feature is essential to the direct structuring induced by femtosecond laser of photoluminescent patterns resulting from a nonlinear phenomenon provoked by the multiphotonic absorption of the material which makes it possible to form silver aggregates. In particular, the materials of the present invention favor the formation of silver aggregates linked to the interaction of silver ions with the femtosecond laser with high repetition rate and with a local spatial distribution of these aggregates, allowing the inscription of structures of variation of refractive index. According to the present invention, by shrewdly associating ions such as Na₂O and BaO with the silver ions, the applicants have found that it is possible to re-inscribe a structure of variation of refractive index in a zone that has already undergone an irradiation.

The materials of the present invention are also transparent in the visible range and in the infrared range. This feature is necessary to allow the use of these materials to produce optical components such as bulk Bragg gratings that are effective for the visible, between 400 nm and 800 nm and the infrared between 800 and 8000 nm.

According to an exemplary embodiment of the invention, the glass is a silver-doped phosphate-gallium glass in which the composition is formulated according to the following relationship (II):

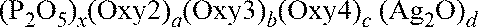

in which
the forming oxide is an oxide of phosphate,
Oxy2 represents oxides such as Ga₂O₃, Al₂O₃, ZnO, preferably Ga₂O₃,
Oxy3 represents an oxide chosen from among CaO, MgO or BaO, preferably MgO,
Oxy4 represents an oxide chosen from among Na₂O, K₂O, Rb₂O or Li₂O, preferably Na₂O,
x lies between 25 and 35, preferably 31
a lies between 5 and 35, preferably 20.6
b lies between 0 and 50, preferably 0
c lies between 0 and 50, preferably 46.4
d lies between 0.1 and 10, preferably 2
x, a, b, c and d are such that x+a+b+c+d = 100, and
in which the numbers x, a, b, c and d represent molar proportions.

An example of glass prepared according to the composition (II) will be presented hereinbelow.

According to another exemplary embodiment of the invention, the glass is a silver-doped germanium-gallium glass in which the composition is formulated according to the following relationship (III):

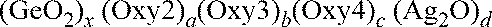

in which
the forming oxide Oxy1 is an oxide of germanium,
Oxy2 represents an oxide chosen from among Ga₂O₃, Al₂O₃, ZnO,
Oxy3 represents an oxide chosen from among MgO, CaO or BaO, preferably BaO,
Oxy4 represents an oxide chosen from among Na₂O or K₂O, Rb₂O or Li₂O, preferably K₂O
x lies between 35 and 45, preferably 43.9
a lies between 0 and 40, preferably 8.8
b lies between 0 and 50, preferably 42.1
c lies between 0 and 50, preferably 3
d lies between 0.1 and 10, preferably 2.2
x, a, b, c and d are such that x+a+b+c+d = 100, and
in which the numbers x, a, b, c and d represent molar proportions.

An example of glass produced according to the composition (III) will be described hereinbelow.

### Device for Inscribing Structures in an Oxide Glass

FIG. 1 illustrates a femtosecond laser inscription device 100. It comprises a femtosecond laser source 101 comprising two amplifying media (Yb: KGW) which generates a laser beam 105. The laser beam is composed of a series of ultrashort light pulses. A femtosecond laser source of sapphire-titanium type is also suitable, another wavelength remaining overall suitable because of the nonlinear nature of the energy deposition and activation of the photochemistry of the silver.

For the exemplary embodiments of structures of variation of refractive index presented hereinbelow, the femtosecond laser used is a t-Pulse 500 laser (marketed by Amplitude Systems). The maximum power is 2.6 W.

The femtosecond laser emits a laser beam having a wavelength lying between 1000 nm and 1100 nm. The wavelength of the laser is chosen so as to be at least two times greater than the cutoff wavelength of the glass of the present invention, a wavelength from which the glass absorbs the light. For the exemplary embodiments, the wavelength can be chosen close to 1030 nm. The emission wavelength of the sapphire-titanium around 800 nm would also be suitable.

The laser is a femtosecond laser. However, the invention can be implemented provided that the pulse duration is less than 1 picosecond, preferably lying between 0.5 ps and 500 fs.

The method for writing structures comprises a configuration in which the chosen repetition rate is between 10 kHz and 100 MHz. While most of the demonstrations of activation of photochemistry of silver have been performed around 10 MHz, observations at 80 MHz, based on a laser/glass interaction from a sapphire-titanium oscillator have already been performed. In fact, this range of repetition rate makes it possible to favor the formation of aggregates and stabilize them.

The parameters of the laser beam such as the repetition rate, the number of pulses and the irradiance, are adapted and controlled to irradiate the glass of the present invention so as to be able to inscribe and re-inscribe three-dimensional structures of variation of optical refractive index at a given depth of the glass without modifying the crystalline structure of the glass. For that, the device further comprises an acousto-optical modulator 102 (AOM) placed at the output of the laser source, on the trajectory of the laser beam. By adjusting the amplitude, the duration and the period of the modulation voltage, it is possible to set the irradiance (power of the beam per unit of surface area), the number and the repetition rate of the pulses of the laser beam passing through the modulator.

The device comprises a microscope lens 103 which makes it possible to focus the material at a determined depth in the bulk of the glass. The numerical aperture of the microscope lies between 0.4 and 1.57 in the case of oil-immersion lenses of very strong numerical aperture. A trade-off in the numerical aperture can be envisaged according to the thickness of the bulk Bragg grating to be produced, according to the refractive index of the glassy matrix, even also the period targeted for the Bragg wavelength targeted for an effective first-order resonance: ideally, to obtain ideal periodicities and therefore optimal efficiencies, it will be recalled that the size D should preferentially be greater than the period targeted, while however taking care to obtain the greatest possible index modulations. The structures have been created in the bulk, typically at a depth of 160 µm under the surface of the sample, the productions having been done with lenses in air and in oil, with numerical apertures of 0.75 and 1.3, respectively. Thus, the structures can be formed at different depths under the surface of the glass. In the exemplary embodiments described hereinbelow, the microscope lens in air focuses the laser beam with a numerical aperture of 0.75, which corresponds to a focal spot of the order of 1.5 µm in diameter leading to index modifications at a distance D ranging from 1.6 to 1.8 µm, typically. In the case of the lens in oil used (NA = 1.3), beam diameters and therefore distances D ranging from 600 nm to 800 nm have been obtained, typically. Focusings with NA < 0.7 are often to be proscribed because they can be accompanied by additional non-linear self-focusing processes, leading to possible distortions of the focus and thus energy deposition that is less well controlled and less well localized spatially. The laser beam is focused at 160 µm under the surface of the glass.

Moreover, the device can comprise a fluorescence and phase contrast microscope to respectively visualize the distribution of the silver aggregates which emits fluorescence and the modification of refractive index in the structured zones of the sample after irradiation according to the method of the present invention.

The sample 10 is disposed on a high-precision plate 105 that is motorized in translation in all three directions with a precision of the order of 30 nm, in order to ensure the correct positioning of the laser beam in the glass. The sample is disposed such that the incident radiation of the beam is preferably at normal incidence on the sample. As FIG. 1 illustrates, the sample extends in a plane (XY) and the axis of propagation of the laser beam extends along an axis Z which is perpendicular to the plane (XY). During the inscription, the glass is translated at right angles to the axis of propagation of the laser beam, at controlled speeds respectively of 10 to 1050 µm.s⁻¹. The movement of the sample during the laser inscription process makes it possible to produce complex three-dimensional structures of variation of optical refractive index (structures of truly 3D type and not only of 2D type corresponding to multiplane approaches).

### Direct Laser Inscription

The emergence of femtosecond laser sources has made it possible to develop 3D direct laser writing technologies in transparent dielectric materials. However, to date, no inscription technology has been proposed for bulk inscribing in a silver-doped oxide glass to induce a positive variation of optical refractive index.

The applicants have surprisingly found that, by controlling the parameters of the laser beam, namely the irradiance, the number of pulses or the relative speed of movement between the beam and the sample and the repetition rate of the pulses, and by choosing glasses with suitable oxide compositions, that it is possible to produce, locally in the bulk of these photosensitive silver-doped oxide glasses, a photochemical phenomenon which induces a positive variation of refractive index of the glass in a peripheral zone around the irradiation point. The applicants further show that, by controlling the parameters of the laser beam, it is also possible to erase the refractive index generated in a preceding irradiation in a portion of this zone of variation of refractive index, by making the portion of this zone coincide with an intense zone of the laser beam (not necessarily the center of the beam) where the intensity is sufficiently high on this portion to induce a photodissociation of silver aggregates accumulated around the irradiation point, which causes the variation of index generated by the distribution of silver aggregates, which are then photodissociated, to be erased. Likewise, the applicants show that it is possible to re-inscribe a zone of variation of refractive index in a zone that has already undergone an erasure of variation of optical index. In other words, the parameters of the laser beam are controlled so as to always maintain, in a zone of the glass having undergone an irradiation, a reservoir of silver ions that is sufficient to ensure a reinscription, that is to say to be able once again to generate an accumulation of silver aggregates in a peripheral zone around the irradiation point.

By virtue of this inscription and reinscription process, and by controlling the parameters that are the irradiance, the repetition rate of the pulses, the number of pulses and the relative speed of movement between the sample and the laser beam, and the positioning between two successive irradiation points, the applicants show that it is possible to produce a grating of planes of variation of refractive index. By producing a series of planes of variation of index, and by ensuring an overlapping of these planes, it is then possible to optimize the geometrical dimension of the index modulation zones and therefore propose the production of a bulk Bragg grating.

### Mechanism For Varying Optical Refractive Index at the Point of Impact of the Beam in a Glass

With reference to FIG. 2, a top view is illustrated of the various phases of the process of a spot interaction of the femtosecond laser beam in a glass of the present invention. The laser irradiation point 11 can be embodied by a circle. This laser inscription or local structuring of the material therefore takes place in a laser interaction volume via multiphotonic absorption processes leading to the formation of electron traps by Ag⁺ ions which are transformed into Ag⁰ and then to the distribution and stabilization of silver aggregates of Agₘ^{x+} type, with m: number of atoms, m < 20 and x: degree of ionization 1 < x < m.

In a first phase of the interaction of the laser during a femtosecond laser pulse, the glass is photoexcited by nonlinear absorption. This is reflected by the generation of a gas of quasi-free electrons which are rapidly trapped by the Ag⁺ ions to form Ag⁰ atoms. The nonlinear nature of the interaction confines the distribution of the Ag⁰ atoms in a zone slightly smaller than the diameter of the laser beam, represented by a dotted line circle in FIG. 2.

In a second phase, in the case where the characteristic thermal diffusion time is greater than the time interval between two laser pulses which lies between 10 µs and 12.5 ns (corresponding to laser repetition rates of 10 kHz to 80 MHz), the temperature of the glass increases locally during the successive deposition of the pulses and generates a scattering of the Agₘ^{x+} metal species from the center (greatly concentrated) to the periphery (weakly concentrated). This migration is represented by the arrows in FIG. 2. The temperature of the glass does not exceed the Tg during the laser interaction process and the glass is maintained in the solid state. The temperature rise in the glasses of the present invention is less than 300° C., which is sufficient to provoke the thermo-activation of the processes of diffusion of the silver ions on the one hand and of the chemical reactivity on the other hand. Agₘ^{x+} metal aggregates 14 are formed between the mobile Ag⁰ species and the Ag⁺ ions.

In the examples presented below, the glass comprises only silver ions. In other embodiments, the metal aggregates are aggregates of gold or of copper. In another embodiment, the material comprises ions of different natures such as gold, copper or silver in different or equal quantities.

The next pulse has the effect of destroying the silver aggregates by a process of photodissociation in the central region of the volume of interaction where the intensity is greater than an intensity that is sufficient to degrade the silver aggregates previously inscribed. Simultaneously, this new pulse regenerates free electrons which are once again trapped to form aggregates on the peripheral zone only.

This sequencing of physical-chemical phenomena and the succession of the pulses lead to a progressive, pulse-after-pulse accumulation of aggregates located in the peripheral zone of the laser beam, that is to say at the point where the laser intensity and the temperature of the glass are sufficiently low to prevent the photodissociation. The result thereof is a variation of refractive index in this peripheral zone generated by an annular spatial distribution of the aggregates in the direct laser inscription process in the case of an inscription around the fixed irradiation point. As FIG. 16 illustrates, in the image (a), the structured zone takes the form of a tube whose axis is borne by the direction Z of propagation of the laser beam. In the plane (X, Y) as the image (c) illustrates in FIG. 2, it takes the form of a ring 15 having a very submicronic thickness e, a very high resolution electron microscopy imaging of which has led to an estimation equal to 80 nm. The diameter of the tube is of the order of the diameter of the beam lying between 0.5 µm and 3 µm.

By controlling the parameters of the laser beam, namely the irradiance, the number of pulses and the pulse repetition rate, the irradiation by femtosecond laser in the oxide glass of the present invention induces a variation of refractive index in the annular zone around the point of irradiation of the beam.

### Mechanism of Formation of Three-Dimensional Structures in an Oxide Glass

The laser beam acts as an optical brush which makes it possible to induce in 3D a variation of optical refractive index on the peripheral zone and erase same at its center.

It is therefore possible to produce bulk 3D structures in the glass, by moving the sample in the two directions X and Y by means of the translation plate with nanometric precision.

With reference to FIG. 3A and to FIG. 3B, the movement of the sample is represented by an arrow in the plane (X, Y) along the axis X and the axis Y is at right angles to the axis of propagation of the laser beam. By moving the sample with the speeds mentioned and the high repetition rates mentioned, the result thereof is a quasi-continuous distribution of superposed irradiation points.

FIG. 3A schematically illustrates the inscription in a sample upon a translational movement of the sample in the direction X, to form an index modulation distribution corresponding to two zones of variation of index that are positive on the edges of the focusing point, these two zones being separated by a distance D. It should be noted that this distance D reflects the distance between the modifications on either side of the focus of the laser beam. Thus, the distance D depends on the size of the focused laser beam but also on the dose of energy deposited which depends on the locally cumulative number of pulses and on the laser irradiation used. FIG. 3A shows the case of a first laser passage along the axis X. FIG. 3B shows the case of the second laser passage, which can then be generalized to N laser passages. The second laser passage is performed, in the reverse direction or in the same direction, with a center-to-center lateral movement Δy which determines the periodicity of the Bragg grating. According to an essential feature of the invention, the center-to-center lateral movements are very much smaller than the distance separating the two zones of variation of index in the preceding passage, such that Δy < D. The zone of variation of index inscribed on the first laser passage, which is then overlapped by the second laser passage, is then erased, while the other zone of variation of index inscribed in the first laser passage remains. Thus, upon the second passage, two new zones of variation of optical refractive index are re-inscribed. This capacity for reinscription in the photosensitive glass makes it possible to conserve, laser passage after laser passage, only one of the two zones of variation of index, with the spatial period imposed by the center-to-center lateral movement Δy of the laser.

FIG. 4 illustrates in more detail by a top view the principle of formation of two planes of variation of refractive index on either side of the line of passage of the laser beam of FIG. 3A from a quasi-continuous succession of irradiation points, the distance between two irradiation points Δx being very much smaller (up to 100 nm) than the diameter of the laser beam D, linked with the pairs of parameters applied which are the high repetition rate of the laser (greater than 10 kHz) and the speed of movement of the sample.

Since the intensity of the laser beam has a Gaussian profile, the result thereof is that the highest energy zone allowing a multiphotonic absorption is located in a central zone of each irradiation point where the phenomenon of photodissociation occurs when silver species already inscribed are located in a zone of strong irradiation. During the translation of the glass sample in the plane, the central zone of the laser beam passes once again substantially over the front edge of the ring previously inscribed. The aggregates formed on the front edge of the beam of the irradiation point referenced j are exposed by the beam of the next irradiation point referenced j+1 (diagram which is not to scale for reasons of clarity because the distance between the points j and j+1 is very small compared to the size of the diameter). The front edge of the ring referenced j is then progressively erased and the latter advances as the laser beam advances. It should be noted that there is no inscription on the back edge of the beam for physical-chemical dynamic reasons internal to the glass during the irradiation while moving. Thus, the result thereof is a writing process only on the edge of the passage of the laser beam, thus forming two parallel planes of variation of refractive index 16, 17 as represented in FIG. 4.

According to an embodiment, to write two planes of variation of refractive index on either side of the line of passage of the laser beam in the glass, the method comprises the following steps:
irradiating, at a first point of irradiation with the beam, the glass, the number of pulses, the repetition rate of the pulses and the irradiance being controlled to induce an accumulation of silver aggregates located in an annular peripheral zone around this first irradiation point in order to generate a variation of refractive index;
moving the glass to irradiate the glass at a second irradiation point, the second irradiation point being arranged with respect to the first irradiation point such that a portion of the peripheral zone generated around the first irradiation point coincides with a substantially central zone of the beam where the intensity of the beam is maximal;
irradiating, at a second irradiation point with the beam, the glass, the number of pulses, the repetition rate of the pulses and the irradiance being controlled to induce, on the one hand, an accumulation of silver aggregates located in an annular peripheral zone around the second irradiation point and, on the other hand, a photodissociation of silver aggregates in the portion in order to erase the variation of refractive index;
repeating the steps such that the zones where the variation of refractive index around the irradiation point remain and form two planes of variation of refractive index.

In the examples of glasses presented hereinbelow, a variation of optical refractive index lying between 10⁻² and 10⁻³ is extracted in the two planes. This variation is induced by an accumulation of aggregates in this zone, and with the local increase of polarizability linked to the creation of these new molecular silver species. The translation on the axis X thus leads to the inscription of two planes of variation of optical index. The two planes are parallel to the axis of translation of the sample X. The distance between the two planes is substantially equal to the diameter of the laser beam, generally between 0.5 µm and 3 µm. The thickness of each plane is less than 200 nm, even approximately 80 nm.

The method of laser inscription in the oxide glasses of the present invention makes it possible to produce, on each passage of the laser beam, the creation of two planes of variation of optical index in the bulk of the glass, by controlling the irradiation parameters of the beam. Thus, a laser beam passage in the glass makes it possible to form two planes exhibiting a variation of refractive index. This method based solely on the photochemistry of the silver ions and of the co-mobile ions makes it possible to achieve submicronic dimensions which are limited little by the focusing of the laser beam and therefore by the spatial extension of the point of irradiation and of energy deposition by multiphotonic absorption. This method therefore allies both a deposition by nonlinear optical process and a photochemistry whose characteristic dimensions are very much smaller than the characteristic lengths of energy deposition on the one hand and of thermal diffusion on the other hand, making it possible to obtain highly contrasting internal dimensions (Δn of some 10⁻³) while having transverse dimensions to a mesoscopic scale (less than 200 nm, even up to 80 nm thick).

With reference to FIG. 3B, it is then possible to write a series of parallel planes of variation of optical refractive index by repeating the inscription process of FIG. 4. To produce the succession of beam passage lines, the sample is moved laterally on the axis Y, in the plane (XY), with a distance Δy.

As in the case of the inscription of the double-plane, the final inscription of each laser beam passage is also conditioned by the distance Δy between two successive passages. When the distance Δy between two laser beam passages is greater than the distance between the two planes which correspond substantially to the diameter of the irradiation point (Δy > D/2), the passages of the laser beam are not superposed and make it possible to inscribe, on each passage, two planes of variation of optical refractive index on either side of the line of passage of the laser. FIG. 5 illustrates an example of three beam passages. Each passage makes it possible to inscribe two planes of variation of optical refractive index, the spacing between the two planes being substantially equal to the diameter of the irradiation point D. Thus, a series of N beam passages makes it possible to inscribe 2N parallel planes of variation of optical refractive index. We then obtain a structure consisting of a pattern of width D (composed of two planes) with a period of Δy. Such a situation is not necessarily the most favorable in terms of periodicity because the overall structure has both a period and an internal structure linked to the duplicated pattern.

When the spacing Δy is less than the distance between the two planes (Δy < D/2), the central zone of the laser beam passes once again over one of the planes previously inscribed which is erased by photodissociation effect. FIG. 6 illustrates an example of three laser beam passages in the glass. A first beam passage makes it possible to inscribe two planes of variation of optical refractive index. A second beam passage, of which the center of the Gaussian profile of the beam passes substantially on one of the two planes inscribed previously in the first passage. By photodissociation effect, the second passage makes it possible to inscribe two planes on either side of the plane erased to a distance substantially equal to D/2. The result thereof is the formation of two planes P1, P2 spaced apart by Δy and a third plane P3 spaced apart by D with respect to the plane P2. Similarly, a third passage makes it possible to inscribe three planes P1, P2, P3 spaced apart at regular intervals by Δy and a fourth plane P4 spaced apart by D with respect to the plane P3. Thus, a series of N beam passages makes it possible to inscribe N planes of variation of optical refractive index with a pitch Λ between two planes substantially equal to Δy and an N+1^{th} plan spaced apart from the N^{th} plane by a distance of D.

In order to be able to re-inscribe a plane of variation of optical refractive index in a zone previously inscribed and erased, that is to say by partially superposing a laser beam passage over the preceding passage, the laser irradiation produced comprising both the pulse intensity and the cumulative number of pulses at each point must be adapted so as to maintain a reservoir of silver ions that is sufficient to allow a reinscription and/or to ensure a photodissociation in terms of silver species that are sufficiently remobilizable upon the next passage.

The method of the present invention, by virtue of a combination of the appropriate parameters, namely the lateral spacing between two laser beam passages, the irradiance and the number of pulses, makes it possible to produce a grating of planes of variation of optical refractive index of a dimension less than 200 nm, even up to 80 nm, with a grating pitch lying between 200 nm and 1.5 µm (which corresponds to the diameter of the focused beam here). Structures having a double line of variation of index can also be produced for greater periods.

### EXAMPLES

The examples which follow are intended to illustrate in more detail the present invention, but are in no way limiting. In particular, the methods described hereinbelow are laboratory methods, which can easily be adapted by the person skilled in the art to an industrial scale.

### Example 1: BGGK (Silver-Doped Germanium-Gallium-Barium-Potassium Glass)

Example 1 relates to a series of silver-doped germanium-gallium-barium-potassium glasses comprising a composition of formula (III). The glass is prepared from gallium oxide, germanium oxide, barium carbonate and silver nitrate.

The glass is prepared according to a conventional melting-tempering method from reagents of high purity. The powders of the reagents are weighed and are introduced into a platinum crucible to be raised to melting point between 1350 and 1400° C. for 15 or so hours. This melting time is adapted to guarantee a uniform dispersion of the Ag⁺ ion on the atomic scale in order to obtain glasses that are optically adapted to receive femtosecond laser irradiation points. The mixture, in the molten liquid state in the crucible, is subjected to a water tempering in order to set the mixture while ensuring the uniformity of the mixture. The mixture is then subjected to a thermal annealing, at a temperature of 30° C. below the melting point Tg for 4 hours. In a final step, the sample is cut to 1 mm thickness then optically polished on two parallel faces.

Table 1 gives the experimental compositions by molar mass of a series of silver-doped germanium-gallium glasses, varying the BaO content.

TABLE 1

| | GaO_{3/2} (mol%) | GeO₂ (mol%) | BaO (mol%) | KO_{½} (mol%) | AgO_{½} (mol%) | Tg (°C) |
|---|---|---|---|---|---|---|
| GGK | 32.0 | 34.7 | 0 | 32.8 | 0.5 | 661 |
| GGB5K | 33.9 | 35.1 | 4.8 | 25.6 | 0.6 | 648 |
| GGB10K | 32.6 | 35.1 | 10.1 | 21.7 | 0.5 | 646 |
| GGB15K | 32.9 | 35.1 | 14.8 | 16.6 | 0.6 | 642 |
| BGGK | 15.4 | 40.5 | 37.5 | 5.3 | 1.3 | 624 |

The glass transition temperatures Tg have been measured. By replacing potassium with barium, a significant reduction of the glass transition temperature of approximately 15° C. is shown.

FIG. 7 shows four curves C1, C2, C3 and C4 respectively representing the trend of the optical index at 480 nm, 589 nm, 644 nm and 656 nm. They show a linear increase for all the wavelengths studied with the barium content.

FIG. 8 shows the optical transmission given as absorption coefficient for the four GGK, GGB5K, GGB10K and GGB15K samples. The measurements show an absorption edge in the UV region of 310 nm that does not vary with the barium content with a transmission extended into the infrared to 5.5 µm. At 6.3 µm, an increasing trend is observed.

In FIG. 9, the GGB15K curve represents the trend of the linear absorption coefficient of the germanate-gallate glass with a BaO content of 15% and the BGGK curve shows the trend of the linear coefficient of the barium germanate glass with a BaO content of 37.5%. Compared to the germanate-gallate glass, the barium germanate glass which comprises a BaO content of 37.5 has a transmission that is shorter in the UV and more extended in the infrared. Thus, the BGGK glass is a very good candidate for the optical applications demanding a transmission window widened into the infrared.

FIG. 10 illustrates spectra of emission at 270 nm and 320 nm and of excitation at 350 nm and 450 nm for the GGB15K and BGGK glasses. For the GGB15K glass, the curves C6 and C7 respectively represent the excitation spectra at 350 nm and 450 nm and the curves C8 and C9 respectively represent the emission spectra at 270 nm and 320 nm. For the BGGK glass, the curves C10 and C11 respectively correspond to the excitation spectra at 350 nm and 450 nm. The curves C12 and C13 represent the emission spectra at 270 nm and 320 nm. These spectra make it possible to reveal the presence of isolated silver ions Ag⁺, of paired ions Ag⁺-Ag⁺ and of Ag⁺ aggregates distributed uniformly in the matrix.

### Direct Laser Inscription

The device illustrated in FIG. 1 is used to implement the method for inscribing structures of variation of refractive index in the BGGK glass.

A 50 × 50 µm² “speed-irradiance” irradiation matrix was produced in the BGGK glass at a depth of 160 µm under infrared femtosecond laser with an irradiance ranging from 6.3 to 8.9 TW.cm² and a speed of movement of the plates ranging from 50 to 1100 µm.s⁻¹. With constant irradiance, the more the speed increases, the less great the energy dose becomes.

The image (a) of FIG. 11 represents a confocal microscopy image of fluorescence of such a “speed-irradiance” irradiation matrix inscribed in the BGGK glass, acquired with a 10× microscope lens and a numerical aperture of 0.3. The image (b) of FIG. 11 represents a zoom of a structure inscribed at 8.4 TW.cm-² and a speed of 50 µm.s⁻¹. It can be observed that the structure exhibits a behavior of double line of fluorescence. The image (c) of FIG. 11 represents a zoom of a structure inscribed at 7.3 TW.cm⁻² and at a speed of 350 µm.s⁻¹. The structure of the image (c) exhibits a very low luminescence with a single line of fluorescence. It is also observed that beyond 8.9 TW.cm⁻¹, microexplosions are observed for all the speeds greater than or equal to 550 µm.s⁻¹.

Thus, to inscribe structures of variation of refractive index in a BGGK glass, the applicants have revealed optimal ranges for the inscription:
pulse duration between 390 fs and 100 fs;
wavelength of the pulses of 1030 nm (but also 800 nm can be envisaged with the sapphire-titanium oscillators);
at a repetition rate of 10 MHz with an ytterbium laser at 1030 nm, but rates up to 80 MHz in the case of an 800 nm sapphire-titanium laser oscillator can also be envisaged, or rates of a few hundreds of kHz with regenerative amplifiers;
irradiance between 7 TW.cm⁻² and 8.4 TW.cm⁻², an irradiance adjusted so as to obtain a strong index contrast which increases with the irradiance while minimizing the risk of damaging the material;
relative speed of movement of the laser beam between 10 µm.s⁻¹ and 1 mm.s⁻¹.

FIG. 12 shows, respectively, a high-resolution confocal microscopic image of fluorescence of the structure inscribed with an irradiance of 8.4 TW.cm⁻² and at a speed of 50 µm.s⁻¹ (image a) and an irradiance of 7.3 TW.cm⁻² and at a speed of 350 µm.s⁻¹ (image b). The images (c) and (d) of FIG. 12 respectively show an image of phase contrast of these same structures.

FIG. 13 represents an overlay of the profiles of fluorescence intensity and of variation of refractive index in the direction of the broken lines for the two structures.

It can be seen in the image (a) of FIG. 12 that the inscribed structure has a behavior of double line of fluorescence. The phase contrast imaging, illustrated in the image (c), reveals the presence of a same double line index variation behavior for a laser beam passage. The average variation of refractive index measured is 2.1 × 10⁻³. In the images (b) and (d), respectively, a behavior of single line of fluorescence and of single line of optical refractive index can be observed. According to the refractive index profile, the index variation is 1 × 10⁻⁴. This behavior of single line of weak index modulation contrast is interpreted as an inscription at the laser inscription threshold and is more like the production of thermally-unstable colored centers (probably an absence of positive charge called a hole h⁺) instead of molecular silver aggregates of greater nuclearity. Such an inscription will not be sought in general for the production of periodic structures such as Bragg gratings.

The applicants observe a spatial overlay between the profile of fluorescence intensity and the profile of index variation for the two inscribed structures, which reflects the fact that the index variation is supported by the accumulation of new silver molecular species (the silver aggregates): the increase of the index then results from the local increase of silver elements but above all by the increased polarizability of these silver molecular species.

### Direct Laser Reinscription

FIG. 14 respectively represents the confocal microscopy images of fluorescence under excitation at 405 nm and of phase contrast of the inscribed structures with a laser passage density per micrometer of 1, 2 and 5 µm.s⁻¹. The applicants find that the fluorescence and the variation of refractive index are maintained at all laser passage densities per micrometer. These results reveal that, when the laser passage density per micrometer allows an overlapping of the inscription lines, that is to say when the spacing between two laser beam passages is less than the diameter of the beam, a phenomenon of reinscription is observed in a zone that has already undergone an irradiation. For these imagings, it should be noted that the instrumentation begins to become inadequate to optically resolve such small periods, notably at 5 µm.s⁻¹, well.

### Bragg Gratings

A Bragg grating consists of a periodic modulation of the refractive index of the material. The Bragg gratings obtained according to the known methods in conventional glasses are generally effective in infrared range just into the red (650 nm), but cannot be used in the entire visible range without using higher orders of diffraction then causing effectiveness to drop. The Bragg gratings that are effective in the visible to the first order of diffraction were produced by using a UV laser but reducing the spatial selectivity conferred by a 3D laser inscription.

The applicants have demonstrated in the present disclosure that it is possible to inscribe and re-inscribe, line-by-line, a periodic structure of variation of refractive index in a silver-doped BGGK glass by shrewdly choosing the composition of the oxides constituting the glass, namely the molar mass of the oxides of gallium, of the oxides of germanium, of the oxides of barium, and of the silver ions, and by choosing the irradiation parameters that are the irradiance, the relative speed of movement of the beam and the spacing between two beam passages.

### Example 2: GPN (Silver-Doped Sodium Gallophosphate Glass)

The example 2 relates to a photosensitive glass comprising a composition according to the relationship (II) produced from gallium oxide, sodium carbonate, phosphoric acid and silver nitrate. Once the precursors have been weighed, they are placed in a beaker to become a solid which is then ground. The powders are introduced into a platinum crucible to be raised to melting point at 1400° C. for 24 hours. This melting time is adapted to guarantee the stabilization and the uniform dispersion on the atomic scale of the Ag⁺ ions in order to obtain glasses that are optically adapted to receive reproducible femtosecond laser irradiation points. The mixture, in the molten liquid state in the crucible, is subjected to a water tempering in order to set the mixture while ensuring the uniformity of the mixture. The mixture is then subjected to a thermal annealing, at a temperature of 30° C. below the melting point Tg for 4 hours. In a final step, the sample is cut to 1 mm thickness and 150 µm, then optically polished on two parallel faces.

Table 2 gives the composition by molar mass of the various constituents of this glass. The silver content is set at 2 mol%. The ratio [O]/[P] = 4.3 reveals an orthophosphate glass. This glass has a low glass transition temperature of 368° C. and almost 50% NaO₂ element. Such a composition allows a strongly photosensitive and chemically durable.

TABLE 2

| | P₂O₅ (mol%) | Ga₃O₂ (mol%) | Na₂O (mol%) | Ag₂O (mol%) | Tg (°C) |
|---|---|---|---|---|---|
| GPN | 31.0 | 20.6 | 46.4 | 2 | 368 |

The GPN glass was subjected to an ultraviolet nanosecond laser irradiation. The emission spectrum obtained for an excitation wavelength at 355 nm shows that the GPN glass has a wide band in the visible range centered toward 550, revealing the majority presence of silver aggregates.

The refractive index n of the glass is 1.541 at 589 nm. The density ρ is 3.08 g.cm⁻³.

This glass exhibits a transparency in the infrared up to approximately 3.2-3.3 µm, the limitation of which is associated with the vibration energies of the phosphate clusters giving rise to various absorptions from 3 µm. In the ultraviolets they exhibit an absorption edge between 250 nm and 350 nm linked to the presence of silver ions in this glass.

### Direct Laser Inscription

The device of FIG. 1 is used to produce structures of variation of refractive index in the GPN glass.

The GPN glass blade is irradiated by laser pulses focused at a depth of 160 µm under the surface of the glass by virtue of the microscope lens of 0.75 numerical aperture and a 20x enlargement. The irradiation pulses have a wavelength of 1030 nm, with a pulse duration of 390 fs, with a repetition rate of 9.1 MHz and a maximum power of 2.6 W. To produce the structures of variation of refractive index shown in FIGS. 16 to 18, it was chosen to irradiate the GPN glass with an irradiance lying between 5 TW.cm⁻² and 10 TW.cm⁻² at a speed lying between 20 µm.s⁻¹ and 200 µm.s⁻¹.

FIG. 15 represents a simulated graphic representation of the variation of refractive index formed in a spot inscription in the GPN glass. The simuated structure is shown in FIG. 15 according to a perspective view (a), a top view (b) and a profile view (c). As explained above, the non-linear multiphotonic process induces a radial distribution of silver aggregates around the center of the spot irradiation point. It forms a structure of variation of refractive index in the form of a tube 30 oriented according to the axis of propagation of the laser beam. The wall 31 of the tube 30 corresponds to the zone that has a variation of refractive index, is formed by molecular entities based on silver aggregates and has a thickness less than 200 nm, even a minimum thickness of approximately 80 nm. The diameter of the tube is similar to that of the irradiation light beam.

FIG. 16 represents an inscription upon a translation of the glass in a direction X as FIG. 4 illustrates. As explained below, there then occurs a phenomenon of photodissociation when the zones of sufficient intensity of the light pulses irradiate silver aggregates formed in a preceding irradiation. The silver aggregates are then redissolved in the form of ions in the glass. Thus, a quasi-continuous succession of aligned irradiation forms an effective structure, in which the distribution of silver aggregates separated by around 10 or so nm, typically, thus corresponding to a continuous distribution on the scale of the optical wavelengths used in the inscription, in the characterization and then in the subsequent use in terms of bulk Bragg grating. This distribution of aggregates and therefore of index variation takes the form of a double plane 40 of which the wall 41 has a positive variation of refractive index. The inscribed structure is represented in FIG. 16 according to a perspective view (a), a top view (b) and a profile view (c).

FIG. 17 represents an inscription of a grating of parallel planes of variation of refractive index by repeating the beam passage of FIG. 17 by moving the sample in a direction X. As explained hereinbelow and with reference to FIG. 6, when the distance between two beam passages is less than the diameter of the beam, the zones of strong intensity of the laser beam make it possible to dissolve a part of the silver aggregates previously inscribed in the preceding laser passage. The silver elements are then in the form of ions in the glass while two new planes of variation of refractive index are formed on either side of the line of passage of the beam via the photochemical phenomenon of creation of new aggregates with the silver ions dissolved in the matrix. This property of reinscription makes it possible to form a periodic structure 50 with parallel planes 51 of positive variation of refractive index with a periodicity Λ = Δy, independently of the diameter D of the beam, primarily for periods Λ = Δy < D. This method makes it possible to inscribe, progressively line-by-line, a periodic structure. The inscribed periodic structure is shown in FIG. 17 according to a perspective view (a), a top view (b) and a profile view (c).

FIG. 18A shows a high-resolution confocal microscopy image of phase contrast of a structure inscribed from a single continuous line. Different laser passages were performed with a spacing of Δy = 5 µm here, which is greater than the diameter of the beam and does not therefore result here in a process of reinscription in this case. FIG. 18B represents a profile of variation of refractive index in a direction at right angles to a single laser passage (schematically represented by a line in FIG. 18A). A variation of refractive index Δn of 2.1 × 10⁻³ is determined in the modified zone, with two planes of variation of index separated by 1.4 µm corresponding typically to the diameter of the laser beam.

### Bragg Grating

The applicants show that it is possible to inscribe and re-inscribe structures of positive variation of refractive index in the GPN glass comprising sodium ions which are co-mobile with the silver. The applicants show that it is possible to inscribe, progressively line-by-line, to form a periodic structure of planes of variation of refractive index of thickness less than 200 nm, even of the order of 80 nm, with a submicronic periodicity controlled by laser inscription with lateral movements Δy < D. By virtue of the combination of the nanometric dimension of the structure and a small periodicity, it is possible to produce Bragg gratings that act in the visible to the first order of diffraction.

FIG. 19 represents a microscopy image showing, step-by-step, the production of a periodic structure. This image was obtained by confocal microscopy of fluorescence of the silver aggregates under excitation at 405 nm. The periodic structure was obtained by the property of reinscription with an irradiance in the 5-10 TW.cm⁻² range and a speed of 200 µm.s⁻¹. The diameter of the beam is approximately 2.2 µm and the distance between two laser beam passages is equal to half the diameter of the beam, namely 1.1 µm.

### INDUSTRIAL APPLICATION

The oxide glass of the present invention offers a benefit and numerous advantages in the photonic domain for the production of optical components such as bulk Bragg gratings, Bragg grating in a waveguide or in the core of an optical fiber. By virtue of the specific glassy composition of the different oxides of the present invention, the glasses exhibit, on the one hand, a strong photosensitivity and, on the other hand, a property of reinscription due to the presence of the ions which are co-mobile with the silver ions. Furthermore, the glass exhibits a spectral range of transmission that is widened compared to the standard glasses in the infrared range. The glass of the invention is particularly suited for a femtosecond laser beam-assisted inscription to fabricate a Bragg grating with lines of variation of nanometric dimension and submicronic grating pitches which can be configured according to the requirements of the applications.

1. A method for producing a three-dimensional structure in the bulk of a transparent oxide glass comprising silver ions, the method comprising
generating a laser beam composed of a series of ultrashort light pulses with a pulse duration shorter than the characteristic time of thermalization of the glass so as to produce an excitation at the irradiation point by multiphonic interaction;
focusing said beam at a desired depth in the glass;
irradiating the glass point by point by said beam so as to form the structure in the glass along a predetermined trajectory, the number of pulses, the repetition rate of the pulses and the irradiance at each irradiation point being controlled to induce an accumulation of silver aggregates located in an annular peripheral zone around an irradiation point, said accumulation of aggregates generating a variation of optical refractive index in the annular peripheral zone around the irradiation point and to erase a variation of optical refractive index in a portion of an annular peripheral zone generated around another irradiation point when said portion of the peripheral zone coincides with a zone of the laser beam.

2. The method as claimed in claim 1, wherein the variation of refractive index Δn is a positive variation of at least greater than 10⁻³.

3. The method as claimed in claim 1, wherein the glass is moved in translation in a direction so as to form a line of passage of the beam formed according to a set of irradiation points, the distance between two irradiation points being substantially equal to half the diameter of the laser beam such that the passage of the laser beam forms two planes of variation of refractive index on either side of the line of passage of the beam.

4. The method as claimed in claim 3, wherein the glass is moved in another direction between two lines of passage of the laser beam so as to form a succession of lines of passage of the beam, the distance between two lines of passage of the beam being less than the diameter of the laser beam such that the succession of passages of laser beam form a grating of planes of variation of refractive index that are parallel to the line of passage of the laser beam.

5. The method as claimed in claim 1, wherein the repetition rate is greater than 10 kHz.

6. The method as claimed in claim 1, wherein the pulse duration of the laser beam is comprised between 100 femtoseconds and 0.5 picoseconds.

7. The method as claimed in claim 1, wherein the irradiance is comrpised between 7 TW.cm⁻² and 8.4 TW.cm².

8. The method as claimed in claim 1, wherein the laser beam is emitted with a wavelength between 515 nm and 1200 nm, preferably at 1030 nm.

9. The method as claimed in claim 1, wherein the glass is moved with respect to the laser beam at a speed V_{D} between 50 µm.s⁻¹ and 1000 µm.s⁻¹.

10. The method as claimed in claim 1, wherein the structure produced is formed by at least one plane of variation of refractive index, the thickness of said plane being less than 200 nm, substantially equal to 80 nm.

11. The method as claimed in claim 10, wherein the structure produced is a periodic structure comprising a plurality of planes of variation of refractive index to form a bulk Bragg grating, with a grating pitch Λ lying between 200 nm and 1.5 µm.

12. The method as claimed in claim 1, wherein the transparent glass, comprises a composition of the following formula (I): 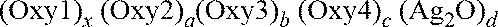
in which
Oxyl is a glass-forming oxide chosen from among silicon oxide SiO₂, an oxide of germanium, or an oxide of phosphate, and
Oxy2 represents an oxide chosen from among Ga₂O₃, Al₂O₃, ZnO,
Oxy3 represents an oxide chosen from among MgO, CaO or BaO, and
Oxy4 represents an oxide chosen from among Na₂O, K₂O, Rb₂O or Li₂O,
x lies between 30 and 80,
a lies between 0 and 65,
b lies between 0 and 65,
c lies between 0 and 65,
d lies between 0.1 and 10, and
x, a, b, d and c are such that x+a+b+c+d = 100, and
in which the numbers x, a, b, d and c represent molar proportions.

13. The method as claimed in claim 12, wherein the composition is formulated according to the following relationship (II): 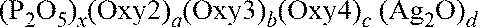
in which
the forming oxide is an oxide of phosphate,
Oxy2 represents oxides such as Ga₂O₃, Al₂O₃, ZnO, preferably Ga₂O₃,
Oxy3 represents an oxide chosen from among CaO, MgO or BaO,
preferably MgO,
Oxy4 represents an oxide chosen from among Na₂O, K₂O, Rb₂O or Li₂O,
preferably Na₂O,
x lies between 25 and 35, preferably 31
a lies between 5 and 35, preferably 20.6
b lies between 0 and 50, preferably 0
c lies between 0 and 50, preferably 46.4
d lies between 0.1 and 10, preferably 2
x, a, b, c and d are such that x+a+b+c+d = 100, and
in which the numbers x, a, b, c and d represent molar proportions.

14. The method as claimed in claim 12, wherein the composition is formulated according to the following relationship (III): 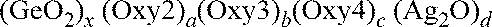
in which
the forming oxide Oxy1 is an oxide of germanium,
Oxy2 represents an oxide chosen from among Ga₂O₃, Al₂O₃, ZnO,
Oxy3 represents an oxide chosen from among MgO, CaO or BaO,
preferably BaO,
Oxy4 represents an oxide chosen from among Na₂O, K₂O, Rb₂O or Li₂O, preferably K₂O,
x lies between 35 and 45, preferably 43.9
a lies between 0 and 40, preferably 8.8
b lies between 0 and 50, preferably 42.1
c lies between 0 and 50, preferably 3
d lies between 0.1 and 10, preferably 2.2
x, a, b, c and d are such that x+a+b+c+d = 100, and
in which the numbers x, a, b, c and d represent molar proportions.

15. The method as claimed in claim 12, further comprising dopants supplementing the composition of the formula (I), (II) or (III) to reach 100% in weight.

16. The method as claimed in claim 15, wherein the dopants are chosen from among the following metallic ions: Ag⁺, Au³⁺, Cu⁺.

17. The method as claimed in claim 1, wherein the transparent glass exhibits a transmission greater than 90% in a range between 400 nm and 8000 nm.
